(19) United States
(12) Patent Application Publication
(10) Pub. No.: US 2011/0191711 A1
(43) Pub. Date: Aug. 4, 2011

(54) CUSTOMER AND VEHICLE DYNAMIC GROUPING

(76) Inventors: George M. GILL, Vilonia, AR (US); Joel A. KUNERT, Maumelle, AR (US); Rajani K. PULAPA, Little Rock, AR (US); Stephen K. RIGSBY, Conway, AR (US)

(21) Appl. No.: 13/021,614

(22) Filed: Feb. 4, 2011

Related U.S. Application Data
(60) Provisional application No. 61/301,349, filed on Feb. 4, 2010.

(51) Int. Cl. G06F 3/048

(52) U.S. Cl. 715/780; 715/810

(57) ABSTRACT

A system and machine-implemented method relating to displaying a first plurality of items, each item including a plurality of values including a first value corresponding to a first field and a second value corresponding to a second field, including receiving a first selection of the first field as a primary grouping field; receiving a second selection of the second field as a secondary grouping field; displaying a plurality of first values included in the first plurality of items, such that each unique value included in the first values is displayed no more than once, in response to the first selection; receiving a third selection of one of the displayed first values; displaying a plurality of second values included in a second plurality of items, wherein each of the second plurality of items is included in the first plurality of items and includes a first value equal to the first value selected in the first selection, such that each unique value included in the plurality of second values is displayed no more than once, in response to the third selection; receiving a fourth selection of one of the displayed second values; and displaying a third plurality of items, each included in the second plurality of items and each including a second value equal to the second value selected in the fourth selection, in response to the fourth selection.

### RELATED APPLICATION

The present invention claims priority of provisional patent application No. 61/301,349 filed on Feb. 4, 2010, the contents of which are incorporated herein in their entirety.

### TECHNICAL FIELD

The present subject matter relates to a user interface for automotive vehicle service equipment. The present subject matter has particular applicability to user interfaces for wheel alignment equipment.

### BACKGROUND

A current conventional vehicle wheel alignment system uses sensors or heads that are attached to the wheels of a vehicle to measure various angles of the wheels and suspension. These angles are communicated to a host system, where they are used in the calculation of vehicle alignment angles. In the standard conventional aligner configuration, four alignment heads are attached to the wheels of a vehicle. Each sensor head comprises two horizontal or toe measurement sensors and two vertical or camber/pitch sensors. Each sensor head also contains electronics to support overall sensor data acquisition as well as communications with the aligner console, local user input, and local display for status feedback, diagnostics and calibration support.

In recent years, wheels of motor vehicles have been aligned in some shops using a computer-aided, three-dimensional (3D) machine vision alignment system. In such a system, one or more cameras view targets attached to the wheels of the vehicle, and a computer in the alignment system analyzes the images of the targets to determine wheel position and alignment of the vehicle wheels from the wheel position data. The computer typically guides an operator to properly adjust the wheels for precise alignment, based on calculations obtained from processing of the image data. A wheel alignment system or aligner of this image processing type is sometimes called a “3D aligner.” Examples of methods and apparatus involving computerized image processing for alignment of motor vehicles are described in U.S. Pat. No. 5,943,783 entitled “Method and apparatus for determining the alignment of motor vehicle wheels;” U.S. Pat. No. 5,809,658 entitled “Method and apparatus for calibrating cameras used in the alignment of motor vehicle wheels;” U.S. Pat. No. 5,724,743 entitled “Method and apparatus for determining the alignment of motor vehicle wheels;” and U.S. Pat. No. 5,535,522 entitled “Method and apparatus for determining the alignment of motor vehicle wheels.” A wheel alignment system of the type described in these references is sometimes called a “3D aligner” or “visual aligner.” An example of a commercial vehicle wheel aligner is the Visualiner 3D, commercially available from John Bean Company of Conway, Ark., a unit of Snap-on Inc.

Alternatively, a machine vision wheel alignment system may include a pair of passive heads and a pair of active sensing heads. The passive heads are for mounting on a first pair of wheels of a vehicle to be measured, and the active sensing heads are for mounting on a second pair of wheels of the vehicle. Each passive head includes a target, and each active sensing head includes gravity gauges for measuring caster and camber, and an image sensor for producing image data, including an image of a target of one of the passive heads, when the various heads are mounted on the respective wheels of the vehicle. The system also includes a spatial relationship sensor associated with at least one of the active sensing heads, to enable measurement of the spatial relationship between the active sensing heads when the active sensing heads are mounted on wheels of the vehicle. The system further includes a computer for processing the image data relating to observation of the targets, as well as positional data from the spatial relationship sensor, for computation of at least one measurement of the vehicle.

A common feature of all the above-described alignment systems is that a computer guides an operator to properly adjust the wheels for precise alignment, based on calculations obtained from processing of the sensor data. These systems therefore include a host computer having a user interface such as a display screen, keyboard, and mouse. Typically, the user interface employs graphics to aid the user, including depictions of the positions of the vehicle wheels, representations of analog gauges with pointers and numbers, etc. The more intuitive, clear, and informative such graphics are, the easier it is for the user to perform an alignment quickly and accurately. There exists a need for an alignment system user interface that enables the user to reduce the time needed to perform an alignment, and enables the user to perform the alignment more accurately.

Additionally, alignment shops typically store and/or have access to many different databases containing information of interest to the user of an alignment system. Such information includes data relating to the particular vehicle being aligned and/or its owner, and other similar vehicles that have been serviced by the shop. This information further includes vehicle manufacturers' technical data, data relating to vehicle parts provided by parts manufacturers, and instructional data. There exists a need for an alignment system user interface that accesses and presents vehicle information to the user on demand, in a desired format, to improve efficiency and accuracy.

### SUMMARY

The teachings herein improve over conventional alignment equipment by providing an improved user interface that enables a user to make use of a vehicle alignment system more quickly and accurately, thereby reducing costs.

The disclosed subject matter relates to a method for displaying a first plurality of items, each item including a plurality of values including a first value corresponding to a first field and a second value corresponding to a second field, the method comprising receiving a first selection of the first field as a primary grouping field; receiving a second selection of the second field as a secondary grouping field; displaying a plurality of first values included in the first plurality of items, such that each unique value included in the first values is displayed no more than once, in response to the first selection; receiving a third selection of one of the displayed first values; displaying a plurality of second values included in a second plurality of items, wherein each of the second plurality of items is included in the first plurality of items and includes a first value equal to the first value selected in the first selection, such that each unique value included in the plurality of second values is displayed no more than once, in response to the third selection; receiving a fourth selection of one of the displayed second values; and displaying a third plurality of items, each included in the second plurality of items and each including a second value equal to the second value selected in the fourth selection, in response to the fourth selection.

Additional advantages and novel features will be set forth in part in the description which follows and in part will become apparent to those having ordinary skill in the art upon examination of the following and the accompanying drawings or may be learned from production or operation of the examples. The advantages of the present teachings may be realized and attained by practice or use of the methodologies, instrumentalities and combinations particularly pointed out in the appended claims.

### BRIEF DESCRIPTION OF THE DRAWINGS

Novel features of the subject technology are set forth in the appended claims. However, for purpose of explanation, several embodiments of the subject technology are set forth in the following figures. Reference is made to the attached drawings, wherein elements having the same reference numeral designations represent like elements throughout, and wherein:

FIG. 1 illustrates an example of a graphic user interface 100 according to an embodiment of the disclosed subject matter.

FIG. 2 illustrates an example of a graphic user interface 200 according to an embodiment of the disclosed subject matter.

FIG. 3 illustrates an example of a graphic user interface 300 according to an embodiment of the disclosed subject matter.

FIG. 4 illustrates an example of a graphic user interface 400 according to an embodiment of the disclosed subject matter.

FIG. 5 illustrates an example of a graphic user interface 500 according to an embodiment of the disclosed subject matter.

FIG. 6 illustrates an example of a graphic user interface 600 according to an embodiment of the disclosed subject matter.

FIG. 7 illustrates an example of a graphic user interface 700 according to an embodiment of the disclosed subject matter.

FIG. 8 illustrates an example of a graphic user interface 800 according to an embodiment of the disclosed subject matter.

FIG. 9 illustrates an example of a graphic user interface 900 according to an embodiment of the disclosed subject matter.

FIG. 10 illustrates an example of a graphic user interface 1000 according to an embodiment of the disclosed subject matter.

FIG. 11 illustrates an example of a graphic user interface 1100 according to an embodiment of the disclosed subject matter.

FIG. 12 illustrates an exemplary architecture of a system in which the disclosed graphical user interface is implemented.

FIG. 13 illustrates a general computer architecture on which the present disclosure can be implemented.

### DETAILED DESCRIPTION

Several examples of graphic user interfaces according to the present disclosure will now be described with reference to the drawings.

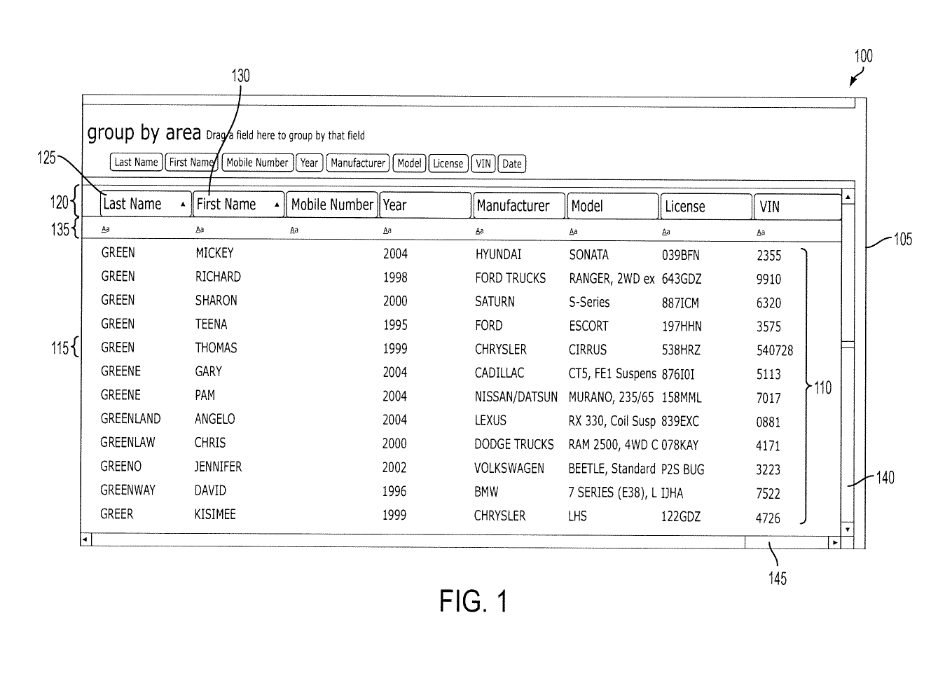

FIG. 1 illustrates an example of a graphic user interface 100 according to an embodiment of the disclosed subject matter. Display area 105 includes item listing 110 of a plurality of items. Each item includes a plurality of values, each value having a respective field. Field header 120 is displayed above item listing 110, providing headers for each column of values which identifies a corresponding field. Button 125, included in field header 120, corresponds to a field entitled “Last Name” (another field identifier may be used internally, for example in storing field information or field values in a database). Button 130, also included in field header 120, corresponds to another field entitled “First Name.” Other fields include fields entitled “Mobile Number,” “Year” (corresponding to a model year for a vehicle represented in the item), “Manufacturer” (corresponding to the manufacturer of the vehicle), “Model” (corresponding to the vehicle model), “License” (corresponding to a license tag number for the vehicle), and VIN (“corresponding to a Vehicle Identification Number, or a part thereof, unique to the vehicle). Item 115 illustrates one of the plurality of items, in which item listing 110 provides a display of values corresponding to each of the fields shown in field header 120, arranged in a table format, with items each occupying a row, and fields each having a respective column of the table. Where the space required to display the fields and their corresponding item values exceeds the display width provided via graphic user interface 100, a horizontal scrollbar 145 is provided to allow the user to scroll through and view the values. Display area 105 also includes a field filtering control area 135, which will be described in more detail below. The buttons provided in field header 120 are effective for controlling sorting of the items displayed in item listing 110. As illustrated in FIG. 1, both buttons 123 and 130 are active for the purpose of sorting items. The arrows shown within each of these buttons indicates they are active for sorting, and might further indicate they are active for sorting values in increasing order. In some embodiments the buttons may configured such that if an arrow were pointing down, instead of up as illustrated in FIG. 1, items would be sorted in decreasing order of their values corresponding to the respective field. By selecting button 125 multiple times, a user can toggle through (a) sorting by the field “Last Name” in increasing order, (b) sorting by decreasing order, and (c) disabling sorting for that particular field. In the particular example illustrated in FIG. 1, items are first sorted based on their values for the field corresponding to button 125, and within groups of those values they are further sorted based on their values for the field corresponding to button 130.

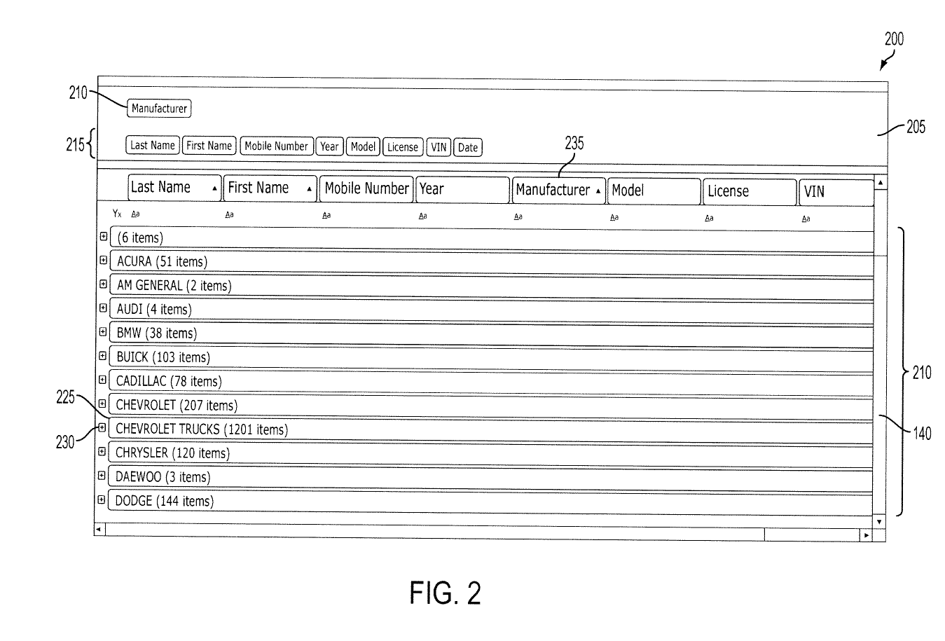

FIG. 2 illustrates an example of a graphic user interface 200 according to an embodiment of the disclosed subject matter. Graphic user interface 200 includes grouping area 205, which is used to control the display of the plurality of items in various groups, based on field values corresponding to the items. Field labels 215 each correspond to a respective field for the items. The field label bearing the text “Last Name” is at a lower level of grouping area 205, indicating that it may be used for grouping items, but that it has not been selected for grouping. In contrast, field label 210, bearing the text “Manufacturer,” has been selected, for example by a “drag and drop” operation (although other mechanisms for selection are well-know in the art), for grouping, as indicated by its position in an user area of grouping area 205.

In response to selecting field label 210 for grouping, group listing 210 is displayed. Field values from the plurality of items corresponding to a first field corresponding to field label 210 are identified, and the set of unique field values from among all of the field values is identified, such that the set of unique field values includes each field value only once. In response to the selection of field label 210, button 235 is also activated for sorting, and by selection of button 235, the sorting may be toggle between increasing order and decreasing order. Instead of listing discrete items, as illustrated in FIG. 1, the unique field values displayed in primary group list 210, sorted according to the toggle state of button 235. Where the number of unique field values is too large for all of the unique field values to be displayed in graphic user interface 200, vertical scrollbar 140 is provided for scrolling through primary group list 210, thereby selectively displaying a subset of the unique field values. Primary group item 225 is one of the items displayed in primary group list 210 illustrated in FIG. 2. Included in primary group item 225 is (a) the corresponding unique field value (“CHEVROLET TRUCKS” in this particular example); (b) the number of the plurality of items which have the indicated field value (1201 items in this particular example); and (c) group selection element 230, via which a user may select the items included in the group corresponding to primary group item 225 (in other words, each of the plurality of items having a field value for “Manufacturer” equal to “CHEVROLET TRUCKS”). In some embodiments, in addition to selecting group selection element 235 for exploring this group of items, a user may also select another portion of primary group item 230.

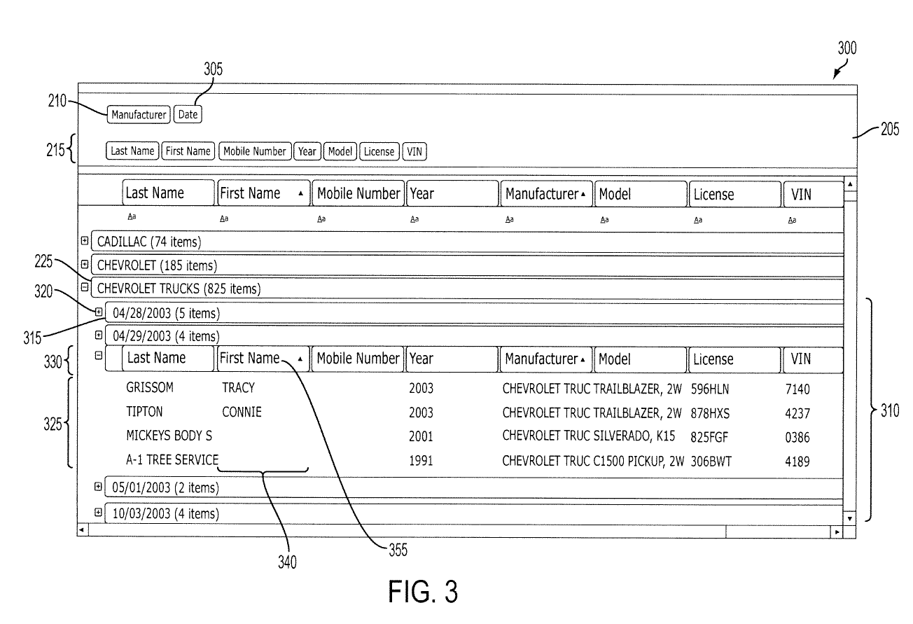

FIG. 3 illustrates an example of a graphic user interface 300 according to an embodiment of the disclosed subject matter. Here, an additional field label 305 (for the field entitled “Date”) has been selected as a secondary grouping field. Its selection as a grouping field is indicated by its location in the upper area of grouping area 205. Such selection may occur by, for example, a “drag and drop” operation from the field labels 215 in the lower area of grouping area 205 to the upper area of grouping area 205. As illustrated in FIG. 3, field label 210 is the primary grouping field, and field label 305 is the secondary grouping field. Additional items from field labels 215 can also be selected, thereby selecting tertiary, etc. grouping fields. As illustrated in FIG. 3, the order from left to right for the field labels displayed in the upper area of grouping area 205 corresponds to their order as grouping fields (i.e., the leftmost is the primary grouping field, the one to its right is the secondary grouping field, etc.). Field labels in the upper area may be exchanged, for example by a “drag and drop” operation. For example, by dragging field label 210 to the right of field label 305, the two field labels would be treated as a request for the primary and secondary grouping fields to be exchanged, such that field label 305 would correspond to the primary grouping field, and field label 210 would correspond to the secondary grouping field. The display of items and groups thereof in graphic user interface 300 would be updated in response to this exchange operation. Those skilled in the art appreciate that many other techniques for selecting and displaying primary, secondary, etc. grouping fields are well-known within the art, and that FIG. 3 and this description are merely illustrative examples.

FIG. 3 illustrates an example in which primary group item 225 has been selected. In response to this selection, secondary group list 310 is displayed. Secondary group list 310 operates in much the same way discussed above with respect to primary group list 210; however, for secondary group list 310 unique field values for the field corresponding to field label 305 are identified from among the group of items corresponding to primary group item 225. Secondary group item 315 corresponds to one of these unique field values, in particular the unique field value “Apr. 28, 2003” (corresponding to vehicles serviced on Apr. 28, 2003). In this example, “Apr. 28, 2003” may be a human-readable format for the internal value used for recording a date. Secondary group includes item group selection element 320, via which a user may select the items included in the group corresponding to secondary group item 315 (in other words, each of the plurality of items having a field value for “Manufacturer” equal to “CHEVROLET TRUCKS” and a field value for “Date” equal to “Apr. 28, 2003”).

In the example illustrated in FIG. 3, the secondary group item corresponding to “Apr. 29, 2003” has been selected. In response to this selection, item listing 110 is displayed. It is noted, however, that is a tertiary grouping field were specified in grouping area 205, instead of item listing 110 there would be another nested group list, similar to secondary group list 310, displayed for the tertiary grouping. Above item listing 325 is field header 330. Much as described above with respect to field header 120 in FIG. 1, field header 330 provides headers for each column of values which identifies a corresponding field. Button 335, included in field header 330, corresponds to the field entitled “Last Name” (as does button 130 illustrated in FIG. 1). The buttons provided in field header 330 are effective for controlling sorting of the items displayed in item listing 325. As illustrated in FIG. 3, button 335 is active for the purpose of sorting items. By selecting button 335 multiple times, a user can toggle through (a) sorting by the field “First Name” in increasing order, (b) sorting by decreasing order, and (c) disabling sorting for that particular field. As can be seen in column 340 for the field corresponding to button 335, the items are being sorted in decreasing order. Listing 325 provides a display of values corresponding to each of the fields shown in field header 330, arranged in a table format, with items each occupying a row, and fields each having a respective column of the table, such as column 340.

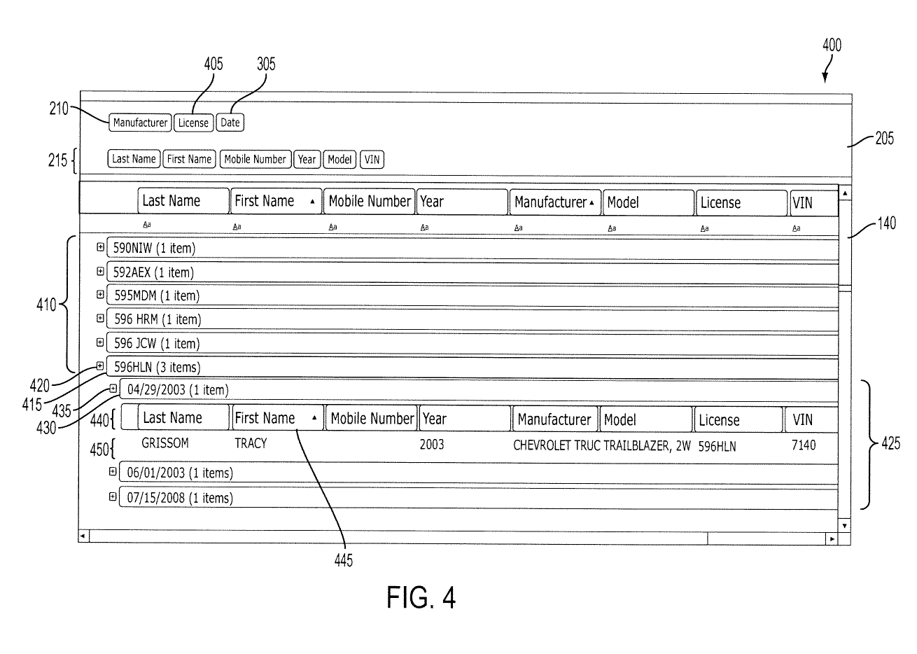

FIG. 4 illustrates an example of a graphic user interface 400 according to an embodiment of the disclosed subject matter. In this example, an additional field label 405 (for the field entitled “License”) has been selected from field labels 215 as a grouping field. In this example, it has been positioned in the upper area of grouping area 205 between field bale 210 and field label 305. As a result, in comparison to FIG. 3, field label 305 is not the secondary grouping field, despite being selected as a grouping field prior in time to field label 405. In the example illustrated in FIG. 4, field label 210 is the primary grouping field, field label 405 is the secondary grouping label, and field label 305 is the tertiary grouping label. Via “drag and drop” operations, for example, field labels 210, 305, and 405 may be exchanged, and additional field labels may be moved up from field labels 205 to identify further grouping fields, and specify an order for grouping.

In FIG. 4, no primary group items are displayed, as the number of displayable items in the illustrated in FIG. 4 is greater than can be displayed at once via graphic user interface 400, as evidenced by scrollbar 140, which allows scrolling through the groups and items to be displayed according to selections made in group area 205 and group items. Those skilled in the art should, in view of the description of FIGS. 2 and 3, appreciate that secondary group list 410 functions in the same manner as secondary group 310. In FIG. 4, secondary group item 415 has been selected, possibly via item group selection element 420. In response to this selection, tertiary group list 425 is displayed, of which tertiary group item 430 has been selected, possibly via item group selection element 435. In response to this selection, item listing 450 is displayed, accompanied by field header 440, which includes button 445. These features operate in much the same manner as listing 325, field header 330, and button 335 illustrated in FIG. 3 and described above, with variations in view of the selection of a tertiary grouping field, as would be understood and implementable by one skilled in the art.

As can be seen in each of FIGS. 2-4, each level of grouping is nested with respect to the grouping above it (as displayed by shifting each level to the right of the level above it). Also, in the illustrated embodiments, group items are displayed with the number of items included in each group.

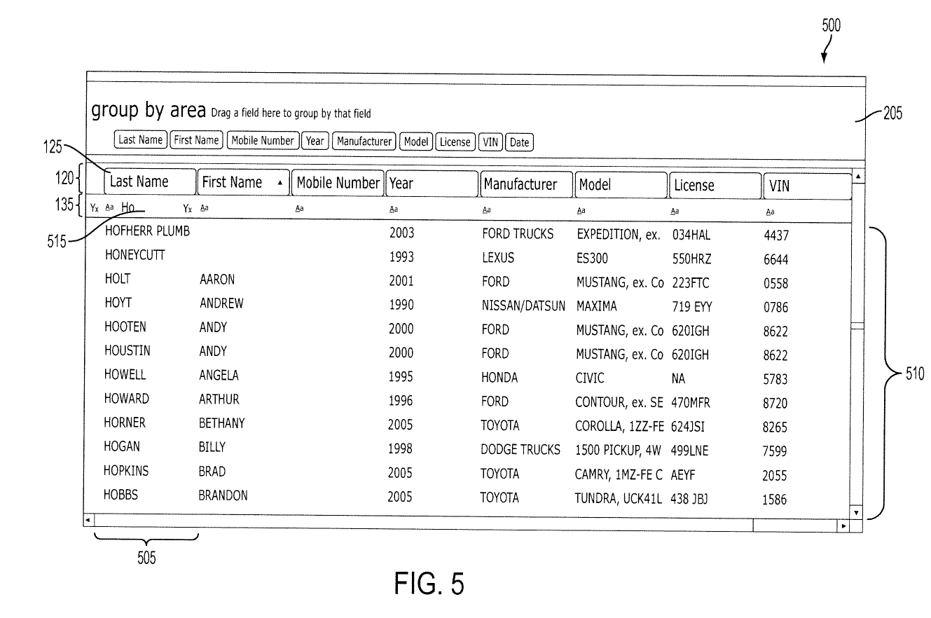

FIG. 5 illustrates an example of a graphic user interface 500 according to an embodiment of the disclosed subject matter. This example is similar to FIG. 1, in that no grouping fields have been selected via grouping area 205. Accordingly, only a listing of items, and not groups of items, is displayed—specifically item listing 510. As in FIG. 1, the example of FIG. 5 includes field header 125, including button 125 corresponding to column 505 for the field labeled “Last Name.” Also, as in FIG. 1, field filtering control area 135 is positioned below field header 120. Field filtering control area 135 includes filter selection element 515 for column 505, and further displays a filter selection area that corresponds to each field specified in field header 120. As illustrated in FIG. 5, a user can enter a text value into filter selection element 515. In response to entering the text value, the plurality of items for display in item listing 510 is filtered using a filter based on the text value. In the example illustrated in FIG. 5, the filter selects items in which the field value for “Last Name” begins with the letters “Ho” (comparison of the letters being done using case-insensitive matching in the illustrated example). As can be seen in FIG. 5, all of the field values displayed in column 505 begin with “HO,” demonstrating the effect of the filter based on the entered text “Ho.” This filtering, and the filtering discussed below, is also effective for nested item listings, such as item listings 325 and 435 discussed above.

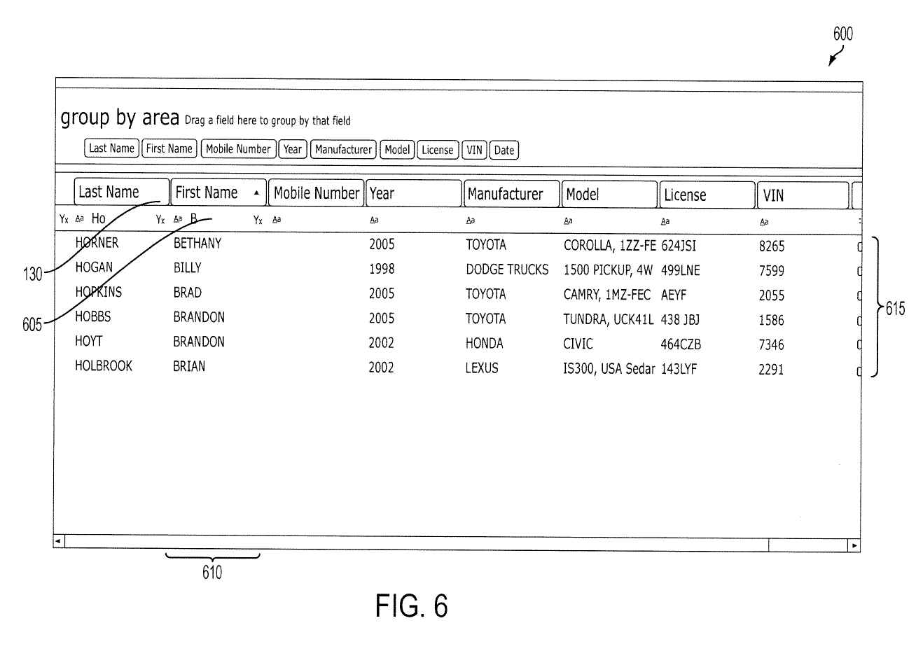

FIG. 6 illustrates an example of a graphic user interface 600 according to an embodiment of the disclosed subject matter. FIG. 6 extends the example illustrated in FIG. 5. In this example, the text “B” has also been entered into filter selection element 605 included in field filtering control area 135. As a result, a filter similar to the one applied in the example of FIG. 5, such that the plurality of items is subjected to both filters. In response to the text entered into filter selection element 605 a smaller set of items is displayed in item listing 615 in comparison to item listing 510 (as evidenced by the lack of a vertical scrollbar). As illustrated in FIG. 6, each of the field values in column 610 begins with “B”, as a result of applying the filter corresponding to filter selection element 605. Additional filter selection elements included in field filtering control area 135 may be used, which further constrain the items displayed. Although the above discussion describes where multiple filters may be applied against items, in some embodiments the information collected via field filtering control area will be combined into a single filter applied against items and the field values therein.

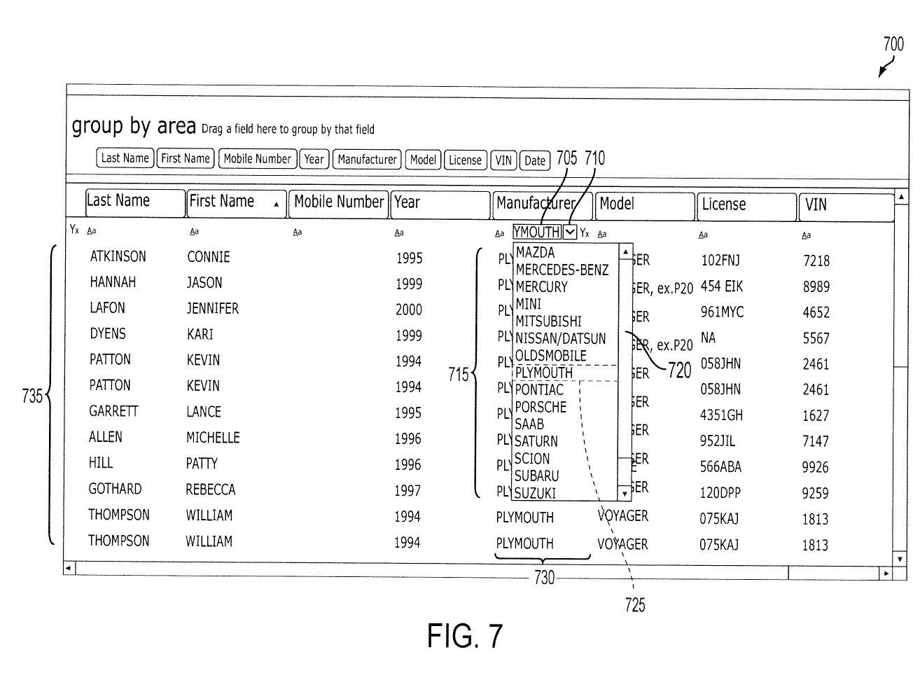

FIG. 7 illustrates an example of a graphic user interface 700 according to an embodiment of the disclosed subject matter. In this example, filter selection element 705 includes a control 710. In response to selecting control 710, listing 715 is displayed, which displays the unique field values used for the items when not subjected to filtering under filter selection element 705 (in other words, the number of unique values may be reduced because other filters have excluded items with certain unique values). A vertical scrollbar 720 is provided in this example because there are too many unique values for direct display in listing 715—instead they must be scrolled to view all of them. In FIG. 7, unique value 725 has been selected, which will be provided as the value for filter selection element 705 to use for filtering. In some embodiments, this selection may be applied “live,” where item listing 735 is constantly updated in response to selecting unique values in listing 715. As illustrated in FIG. 7, each of the values in column 730 is “PLYMOUTH,” corresponding to the selected value 725.

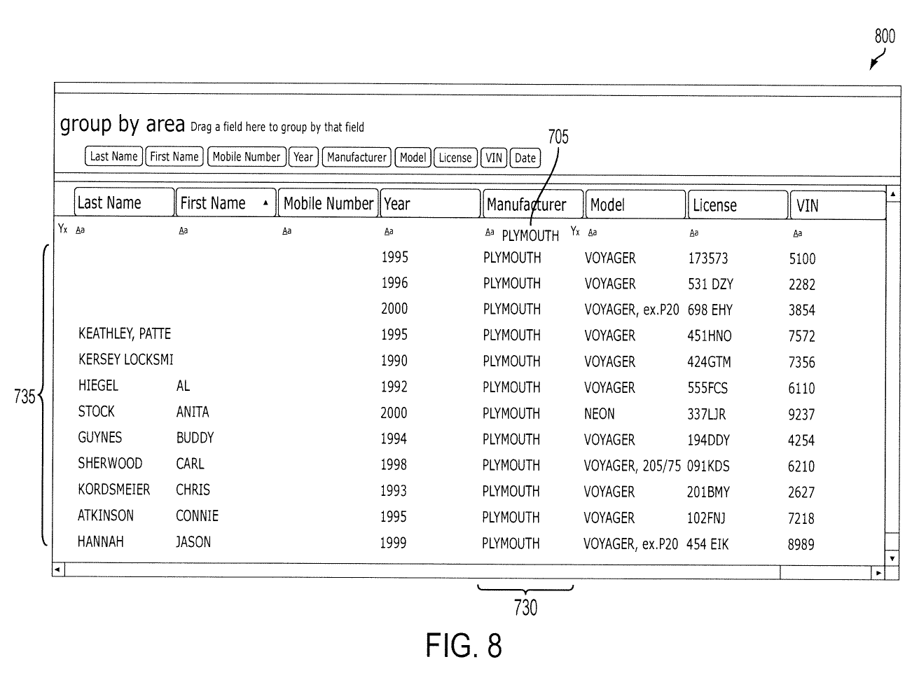

FIG. 8 illustrates an example of a graphic user interface 800 according to an embodiment of the disclosed subject matter. FIG. 8, simply illustrates where the selection illustrated in FIG. 7 has been completed, and the resultant item listing 735, in which each value in column 730 has the value shown in and selected via filter selection element 705.

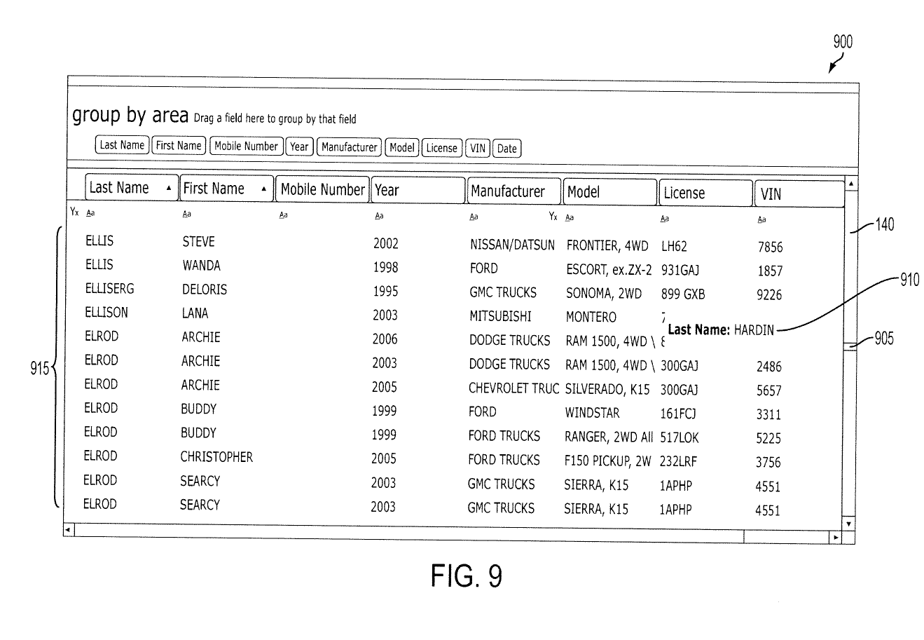

FIG. 9 illustrates an example of a graphic user interface 900 according to an embodiment of the disclosed subject matter. In many of the above examples, there have been group or item listings with too many items to display at once, resulting in a vertical scrollbar such as vertical scrollbar 140 illustrated in FIG. 9. Included in vertical scrollbar 140 is position selection element 905. Graphical user interface 900 is configured such that as position selection element 905 is moved in the vertical direction, instead of constantly updating item listing 915 in response to movement of position selection element 905, position indicator 910 is provided to indicate a field value for the first item in the group or item listing that will result from moving position selection element 905. In the illustrated example, position selection element 905 was initially in a position such that the first item of item listing has a field value of “ELLIS” of the “Last Name” field. However, position selection element 905 has been moved such that if released at the shown position, the first item of the updated item listing will have a field value of “HARDIN” of the “Last Name” field.

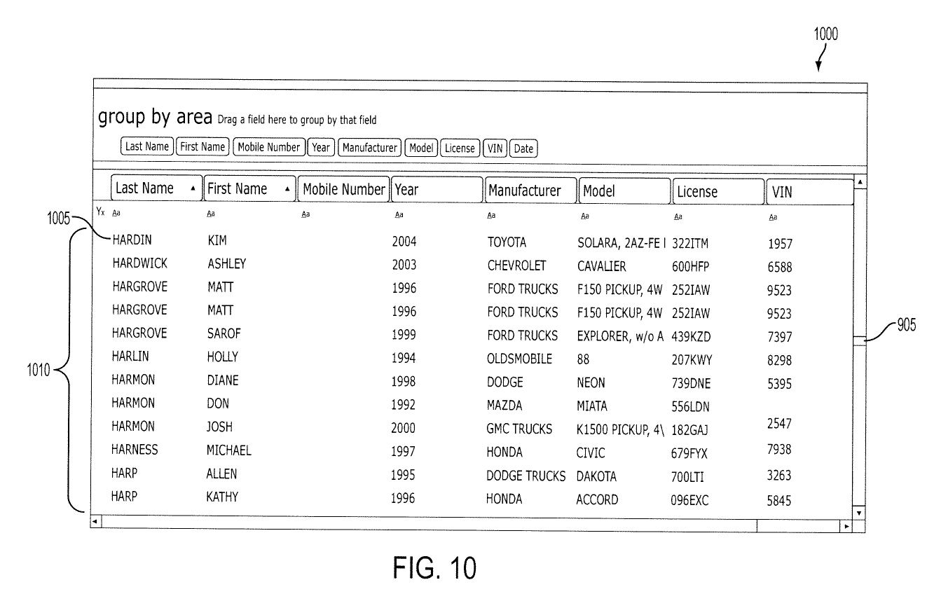

FIG. 10 illustrates an example of a graphic user interface 1000 according to an embodiment of the disclosed subject matter. FIG. 10 continues the example illustrated in FIG. 9 discussed above. In FIG. 10, the user has released position selection element 905 at the position shown in FIG. 9. As a result of selecting this position for position selection element 905, item listing 1010 is updated (or scrolled), and item listing 1005 at the beginning of item listing 1010 has a field value of “HARDIN” of the “Last Name” field, as was indicated by position indicator 910 in FIG. 9. The technique illustrated in FIGS. 9 and 10 provides an alternative to conventional techniques for scrolling. This technique is particularly useful for scrolling through large numbers of items, as it may be configured to reduce the amount of field value information that is obtained in the process of scrolling. For example, with the conventional technique, where the item listing would be continuously updated, a great deal of information would be displayed in the item listing during this updating that would generally not be of interest, and would have to be obtained, processed, and displayed with associated overhead. In another conventional technique for scrolling, there would be no continuous updating of the item listing with movement of position selection element 905—instead it would only be refreshed once position selection element 905 is released. However, without position indicator 910, a user is left to find the desired position by trial and error, typically by under- and over-shooting the desired position.

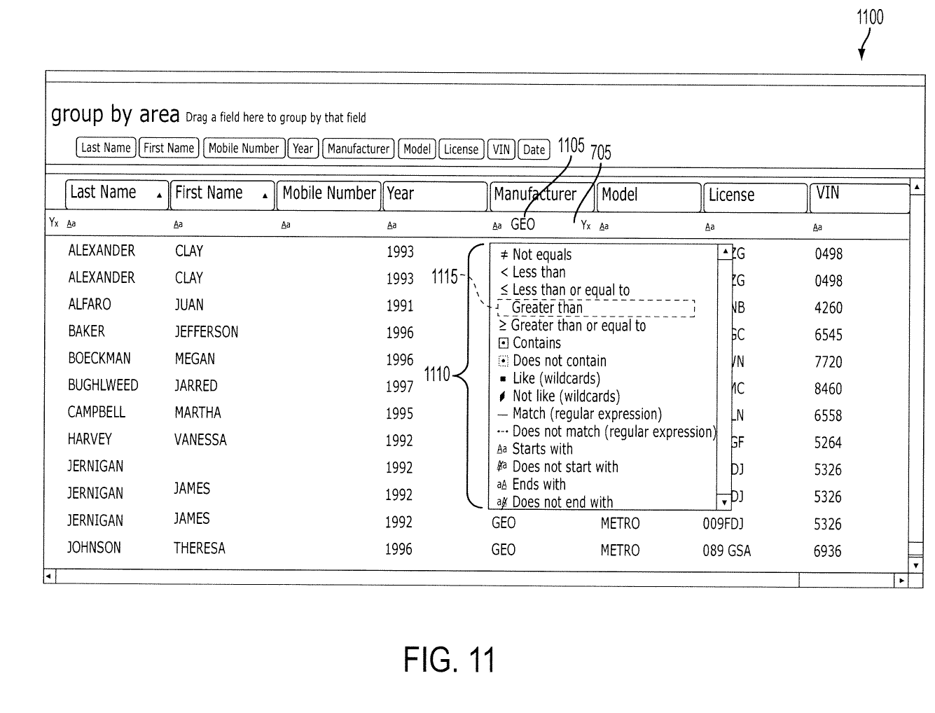

FIG. 11 illustrates an example of a graphic user interface 1100 according to an embodiment of the disclosed subject matter. In this example, filter selection element 705 allows the user to select an operator listing 1110. With operator listing 1110, the user may select, in addition to text value 1105, an operator which controls the filtering. Examples are illustrated directly in FIG. 11. The user may select one of the listed operators, such as selected filter operator 1115. In this particular example, selected filter operator 1115 is “< Greater than.” In response to selecting this particular filter operator, the filtering corresponding to filter selection element 705 will accept field values for the “Manufacturer” field with a value greater than “GEO” (e.g., “HONDA,” PONTIAC,” and “TOYOTA”). As can be seen by the brief descriptions of these operators in FIG. 11, wildcards may be included in the text entered into filter selection element 705, which will be used by the resulting filtering.

As one skilled in the art would appreciate, the data for the plurality of items may be stored and obtained in many ways. For example, of the data may be stored within the system displaying the information. In some embodiments, the data may be persistently stored in a database outside of the system displaying the information, whether on a local network or a more extended network such as the Internet. In such embodiments, the information used to determine which information is displayed is obtained via queries to the database.

Additionally, although the above examples describe displaying information, displayed items or field values may also be modified. This includes, adding, deleting, or modifying such items or field values. In embodiments utilizing a centralized database system for storing such information, such modifications will result in requests to modify the contents of the database.

The above description discusses “selecting” various features. Many techniques for such selection are well known in the art, including, but not limited to, use of a mouse device (including a scroll wheel), a touchscreen device, and a keyboard.

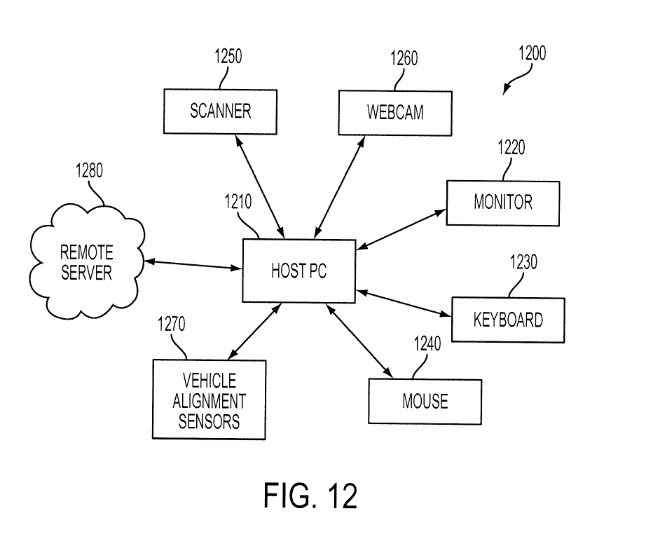

FIG. 12 is an exemplary architecture of a system 1200 that is an environment for implementing the user interface of the present disclosure. In system 1200, a host computer, such as a commercially available personal computer (PC) 1210, is connected to conventional input and output devices such as monitor 1220, keyboard 1230, mouse 1240, scanner 1250, and webcam 1260. Monitor 1220 is a conventional monitor, or a conventional touch screen for accepting user input. PC 1210 is further connected to vehicle alignment sensors 1270 of a vehicle wheel alignment system as discussed in the “Background” section herein above. A conventional remote server 1280 is also connected to host PC 1210. Server 1280 provides content from various databases described herein to PC 1210. Such content is either stored at server 1280, or obtained via the Internet or another remote data network. PC 1210 can also send data to server 1280; for example, to update certain databases stored at server 1280.

Computer hardware platforms may be used as the hardware platform(s) for one or more of the user interface elements described herein. The hardware elements, operating systems and programming languages of such computers are conventional in nature, and it is presumed that those skilled in the art are adequately familiar therewith to adapt those technologies to implement the graphical user interface essentially as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

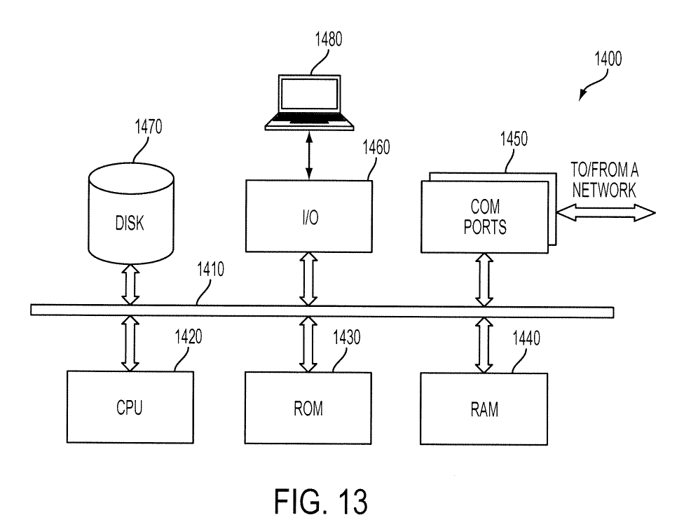

FIG. 13 provides a functional block diagram illustration of a computer hardware platform which includes user interface elements. The computer may be a general purpose computer or a special purpose computer. This computer 1400 can be used to implement any components of the graphical user interface as described herein. For example, the software tools for generating the carousel control and nested user interface elements can all be implemented on a computer such as computer 1400, via its hardware, software program, firmware, or a combination thereof. Although only one such computer is shown, for convenience, the computer functions relating to processing of the disclosed user interface may be implemented in a distributed fashion on a number of similar platforms, to distribute the processing load.

The computer 1400, for example, includes COM ports 1450 connected to and from a network connected thereto to facilitate data communications. The computer 1400 also includes a central processing unit (CPU) 1420, in the form of one or more processors, for executing program instructions. The exemplary computer platform includes an internal communication bus 1410, program storage and data storage of different forms, e.g., disk 1470, read only memory (ROM) 1430, or random access memory (RAM) 1440, for various data files to be processed and/or communicated by the computer, as well as possibly program instructions to be executed by the CPU. The computer 1400 also includes an I/O component 1460, supporting input/output flows between the computer and other components therein such as user interface elements 1480. The computer 1400 may also receive programming and data via network communications.

Hence, aspects of the methods of generating the disclosed graphical user interface, e.g., the carousel control and nested controls, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on a PC or server. In addition, the user interface and its components as disclosed herein can be implemented as a firmware, firmware/software combination, firmware/hardware combination, or a hardware/firmware/software combination.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the present teachings. However, it should be recognized that the present teachings can be practiced without resorting to the details specifically set forth. In other instances, well known processing structures have not been described in detail, in order not to unnecessarily obscure aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method for displaying a first plurality of items, each item including a plurality of values including a first value corresponding to a first field and a second value corresponding to a second field, the method comprising:
receiving a first selection of the first field as a primary grouping field;
receiving a second selection of the second field as a secondary grouping field;
displaying a plurality of first values included in the first plurality of items, such that each unique value included in the first values is displayed no more than once, in response to the first selection;
receiving a third selection of one of the displayed first values;
displaying a plurality of second values included in a second plurality of items, wherein each of the second plurality of items is included in the first plurality of items and includes a first value equal to the first value selected in the first selection, such that each unique value included in the plurality of second values is displayed no more than once, in response to the third selection;
receiving a fourth selection of one of the displayed second values; and
displaying a third plurality of items, each included in the second plurality of items and each including a second value equal to the second value selected in the fourth selection, in response to the fourth selection.

2. The method of claim 1, wherein the plurality of values included in each of the first plurality of items further includes a third value corresponding to a third field, the method further comprising:
receiving a fifth selection of the third field as a sorting field; and
displaying the third plurality of items, such that the third plurality of items is sorted according to the third value included in each item, in response to the fifth selection.

3. The method of claim 1, further comprising:
receiving a text string in association with the third field; and
displaying a fourth plurality of items, each included in the third plurality of items and satisfying a filter based on the text string, in response to receiving the text string.

4. The method of claim 1, wherein the plurality of values included in each of the first plurality of items further includes a third value corresponding to a third field, the method further comprising:
receiving a fifth selection of the first field as a sorting field; and
displaying a second plurality of first values included in the first plurality of items, such that each unique value included in the first values is displayed no more than once and the second plurality of first values is sorted, in response to the fifth selection.

5. The method of claim 1, further comprising:
receiving a text string in association with the third field; and
displaying a second plurality of first values included in the first plurality of items, such that each unique value included in the first values satisfies a filter based on the text string and is displayed no more than once, in response to receiving the text string.

6. The method of claim 1, further comprising:
receiving a request to exchange the primary grouping field and the secondary grouping field, such that the second field is the primary grouping field and the first field is the secondary grouping field;
displaying a plurality of second values included in the first plurality of items, such that each unique value included in the second values is displayed no more than once, in response to the first selection;
receiving a fifth selection of one of the displayed second values;
displaying a plurality of first values included in a fourth plurality of items, wherein each of the fourth plurality of items is included in the first plurality of items and includes a second value equal to the second value selected in the fifth selection, such that each unique value included in the plurality of first values is displayed no more than once, in response to the fifth selection;
receiving a sixth selection of one of the displayed first values; and
displaying a fifth plurality of items, each included in the fourth plurality of items and each including a first value equal to the first value selected in the sixth selection, in response to the sixth selection.

7. A computer system for displaying a first plurality of items, each item including a plurality of values including a first value corresponding to a first field and a second value corresponding to a second field, the computer system comprising:
a processor; and
a computer readable medium having computer-executable instructions that, when executed by the processor, cause the computer system to:
receive a first selection of the first field as a primary grouping field;
receive a second selection of the second field as a secondary grouping field;
display a plurality of first values included in the first plurality of items, such that each unique value included in the first values is displayed no more than once, in response to the first selection;
receive a third selection of one of the displayed first values;
display a plurality of second values included in a second plurality of items, wherein each of the second plurality of items is included in the first plurality of items and includes a first value equal to the first value selected in the first selection, such that each unique value included in the plurality of second values is displayed no more than once, in response to the third selection;
receive a fourth selection of one of the displayed second values; and
display a third plurality of items, each included in the second plurality of items and each including a second value equal to the second value selected in the fourth selection, in response to the fourth selection.

8. The computer system of claim 7, wherein the plurality of values included in each of the first plurality of items further includes a third value corresponding to a third field, and the computer-readable medium has computer-executable instructions that, when executed by the processor, cause the computer system to:
receive a fifth selection of the third field as a sorting field; and
display the third plurality of items, such that the third plurality of items is sorted according to the third value included in each item, in response to the fifth selection.

9. The computer system of claim 7, wherein the computer-readable medium has computer-executable instructions that, when executed by the processor, cause the computer system to:
receive a text string in association with the third field; and
display a fourth plurality of items, each included in the third plurality of items and satisfying a filter based on the text string, in response to receiving the text string.

10. The computer system of claim 7, wherein the plurality of values included in each of the first plurality of items further includes a third value corresponding to a third field, and the computer-readable medium has computer-executable instructions that, when executed by the processor, cause the computer system to:
receive a fifth selection of the first field as a sorting field; and
display a second plurality of first values included in the first plurality of items, such that each unique value included in the first values is displayed no more than once and the second plurality of first values is sorted, in response to the fifth selection.

11. The computer system of claim 7, wherein the computer-readable medium has computer-executable instructions that, when executed by the processor, cause the computer system to:
receive a text string in association with the third field; and
display a second plurality of first values included in the first plurality of items, such that each unique value included in the first values satisfies a filter based on the text string and is displayed no more than once, in response to receiving the text string.

12. The computer system of claim 7, wherein the computer-readable medium has computer-executable instructions that, when executed by the processor, cause the computer system to:
receive a request to exchange the primary grouping field and the secondary grouping field, such that the second field is the primary grouping field and the first field is the secondary grouping field;
display a plurality of second values included in the first plurality of items, such that each unique value included in the second values is displayed no more than once, in response to the first selection;
receive a fifth selection of one of the displayed second values;
display a plurality of first values included in a fourth plurality of items, wherein each of the fourth plurality of items is included in the first plurality of items and includes a second value equal to the second value selected in the fifth selection, such that each unique value included in the plurality of first values is displayed no more than once, in response to the fifth selection;
receive a sixth selection of one of the displayed first values; and
display a fifth plurality of items, each included in the fourth plurality of items and each including a first value equal to the first value selected in the sixth selection, in response to the sixth selection.

13. A computer readable medium having instructions that, when executed by a computer system, cause the computer system to:
receive a first selection of the first field as a primary grouping field;
receive a second selection of the second field as a secondary grouping field;
display a plurality of first values included in the first plurality of items, such that each unique value included in the first values is displayed no more than once, in response to the first selection;
receive a third selection of one of the displayed first values;
display a plurality of second values included in a second plurality of items, wherein each of the second plurality of items is included in the first plurality of items and includes a first value equal to the first value selected in the first selection, such that each unique value included in the plurality of second values is displayed no more than once, in response to the third selection;
receive a fourth selection of one of the displayed second values; and
display a third plurality of items, each included in the second plurality of items and each including a second value equal to the second value selected in the fourth selection, in response to the fourth selection.

14. The computer-readable medium of claim 13, wherein the plurality of values included in each of the first plurality of items further includes a third value corresponding to a third field, and the computer-readable medium has computer-executable instructions that, when executed by the processor, cause the computer system to:
receive a fifth selection of the third field as a sorting field; and
display the third plurality of items, such that the third plurality of items is sorted according to the third value included in each item, in response to the fifth selection.

15. The computer-readable medium of claim 13, having computer-executable instructions that, when executed by the processor, cause the computer system to:
receive a text string in association with the third field; and
display a fourth plurality of items, each included in the third plurality of items and satisfying a filter based on the text string, in response to receiving the text string.

16. The computer-readable medium of claim 13, wherein the plurality of values included in each of the first plurality of items further includes a third value corresponding to a third field, and the computer-readable medium has computer-executable instructions that, when executed by the processor, cause the computer system to:
receive a fifth selection of the first field as a sorting field; and
display a second plurality of first values included in the first plurality of items, such that each unique value included in the first values is displayed no more than once and the second plurality of first values is sorted, in response to the fifth selection.

17. The computer-readable medium of claim 13, having computer-executable instructions that, when executed by the processor, cause the computer system to:
receive a text string in association with the third field; and
display a second plurality of first values included in the first plurality of items, such that each unique value included in the first values satisfies a filter based on the text string and is displayed no more than once, in response to receiving the text string.

18. The computer-readable medium of claim 13, having computer-executable instructions that, when executed by the processor, cause the computer system to:
receive a request to exchange the primary grouping field and the secondary grouping field, such that the second field is the primary grouping field and the first field is the secondary grouping field;
display a plurality of second values included in the first plurality of items, such that each unique value included in the second values is displayed no more than once, in response to the first selection;
receive a fifth selection of one of the displayed second values;
display a plurality of first values included in a fourth plurality of items, wherein each of the fourth plurality of items is included in the first plurality of items and includes a second value equal to the second value selected in the fifth selection, such that each unique value included in the plurality of first values is displayed no more than once, in response to the fifth selection;
receive a sixth selection of one of the displayed first values; and
display a fifth plurality of items, each included in the fourth plurality of items and each including a first value equal to the first value selected in the sixth selection, in response to the sixth selection.
